(19) United States
(12) Patent Application Publication
(10) Pub. No.: US 2006/0222903 A1
(43) Pub. Date: Oct. 5, 2006

(54) Structure and process for production thereof

(75) Inventors: Shigeru Ichihara, Tokyo (JP); Toru Den, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Ohta-ku (JP)

(21) Appl. No.: 11/389,226

(22) Filed: Mar. 27, 2006

(30) Foreign Application Priority Data
Mar. 31, 2005 (JP) 2005-102597
Sep. 16, 2005 (JP) 2005-270286

(51) Int. Cl. G11B 5/66; B05D 3/02; B05D 1/18

(52) U.S. Cl. 428/827; 427/372.2; 427/430.1

(57) ABSTRACT

A novel structure is provided in which an ordered alloy material is filled in pores of the structure. A process for producing the structure is also provided. The process comprises a first step for forming an alloy in pores of a porous layer, a second step for forming a film composed of a second material on the porous layer, and a third step for heat-treating the porous layer having the film.

### BACKGROUND OF THE INVENTION

1. Field of the Invention

The present invention relates to a structure having pores, particularly to a structure useful for forming a recording layer of a magnetic recording medium.

2. Description of Related Art

The hard disk which is a main recording device of a personal computer has been improved to have remarkably high recording density. The hard disks are investigated for use as the recording medium, not only for the PC but also for digital household electric appliances and mobile terminals, and are promising for higher recording density.

The hard disk conventionally used is of a longitudinal recording system in which magnetization is held in the disk face direction in the disk. In this system, the magnetic recording layer should be thin to prevent decrease of the demagnetization field in the magnetic domains. The decrease of the thickness of the magnetic recording layer results in decrease of the volume of the magnetic particles contained therein. This makes non-negligible the thermal energy of the particles in comparison with the magnetic energy retained therein. That is, the longitudinal recording type of hard disk having a thin magnetic recording medium will be affected remarkably by superparamagnetism (thermal fluctuation) to dissipate the recorded magnetization.

On the contrary, in the vertical recording system in which magnetization is held in a direction vertical to the disk face, the superparamagnetization can be suppressed by keeping the thickness of the layer.

The recording layer of the vertical magnetic recording medium is conventionally formed mainly from a CoCr type alloy. Recently, however, hard magnetic ordered alloys of a CuAu type (hereinafter referred to as an “L1₀ type”) or a Cu₃Au type (hereinafter referred to as an “L1₂ type”) are attracting attention which are capable of suppressing the superparamagnetization even with a smaller size of the recording region and have a high magnetic anisotropic constant.

The material FePt can become an L1ₒ type ordered alloy. For formation of the L1ₒ type FePt ordered alloy, a film thereof is heat-treated for ordering. Japanese Patent Application Laid-Open No. 2003-006830 (Patent Document 1) discloses a process in which a continuous film composed of Fe and Pt is formed on a substrate and the film is heat treated at 350° C.

For increasing the recording density, the magnetic exchange bond between the magnetic regions should be broken or weakened. For the purpose, it is effective to isolate the magnetic regions from each other by a non-magnetic material composed of an oxide or the like. Japanese Patent Application Laid-Open No. 2002-175621 (Patent Document 2) prepares an ordered alloy structure by filling a magnetic material like CoPt into pores of a structure constituted of anodized alumina and heat-treating the structure at a temperature of 650° C. This heat treatment temperature is higher than the temperature 350° C. for the ordering of the continuous film as described in Patent Document 1. Therefore, improvement is desired at least to lower the heat treatment temperature below 650° C.

### SUMMARY OF THE INVENTION

The present invention intends to provide a process for producing a structure containing, in pores, an alloy ordered by heat treatment at a temperature lower than 650° C., and to provide a novel structure produced by the process.

According to an aspect of the present invention, there is provided a process for producing a structure containing an ordered alloy in pores in a porous layer comprising the steps of: providing a porous layer-containing member having a porous layer on the surface thereof,

filling a first material for being comprised in the alloy into pores of the porous layer, forming a film containing a second material on the porous layer, and

heat-treating the member having the film.

According to another aspect of the present invention, there is provided a process for producing a structure containing an ordered alloy in pores in a porous layer comprising the steps of:

providing a porous layer-containing member having a porous layer on the surface thereof,

filling a first material for being comprised in the alloy into pores of the porous layer,

forming on the porous layer-containing member a film from a second material for being comprised in the alloy to be connected with the filled first material and to cover the openings of the pores and the other portions of the porous layer than the openings, and heat-treating the porous layer-containing member with the film covering the openings and the other portions than the openings.

The first material and the second material may be different from each other.

One of the first material and the second material preferably contains at least one element selected from the group consisting of Fe, Co and Ni, and the other one of the first material and the second material contains at least one of the elements of Pt and Pd.

The first material and the second material may be the same.

The ordered structure of the ordered alloy is preferably an L1₀ type structure or an L1₂ type structure.

The pores of the porous layer are preferably columnar, having an average diameter ranging from 1 nm to 40 nm.

The pore-filling step and the film-forming step are preferably conducted by plating the material constituting the alloy. The plating treatment is preferably conducted to allow the material to overflow from the pores of the porous layer and to allow the material having overflowed to join together to be continuous on the other portions than the openings of the pores.

At least one of the pore-filling step and the film-forming step is preferably conducted by a dry process by use of the material constituting the alloy.

The film formed in the film-forming step on the porous layer-containing member is preferably a continuous film having a thickness of not less than 1 nm.

The process preferably further comprises, after the film-forming step, a step for forming a second film containing a third material on the film. The second film preferably serves to lower the temperature for orientation control and/or ordering of the alloy. Alternatively, the second film is preferably selected from films of ZnO, MgO, and Cu, and lamination films of Cu and Si.

The heat-treating step is preferably conducted in a reductive atmosphere.

The process preferably comprises a step of removing the film from the member.

According to a still another aspect of the present invention, there is provide a process for producing a structure containing an ordered alloy in pores in a porous layer comprising the steps of: providing a porous layer-containing member having a porous layer on a surface,

filling a first material for being comprised of the alloy in the pores of the porous layer,

forming a film containing a second material on the porous layer to be in contact with the filled first material, and

treating the filled first material for formation of an ordered alloy.

According to a further aspect of the present invention, there is provided a structure having a member having a columnar pores on a substrate and containing a filling in the pores, wherein the filling has a first region and a second region in the depth direction of the columnar pore,

the first region is an ordered alloy region, and

the second region is an ordered alloy region of a lower ordering degree than the first region, non-alloyed region, or a region having an ordered structure different from the first region.

According to a further aspect of the present invention, there is provided a recording medium having a magnetic layer on a substrate, wherein the magnetic layer is constituted of a first magnetic layer and a second magnetic layer; in the first magnetic layer, a first magnetic material is distributed in a non-magnetic material, and in the second magnetic layer, a second magnetic material is continuous. The first magnetic material and the second magnetic material are preferably different in a magnetic property. Alternatively, the first magnetic layer has preferably a larger coercive force than the second magnetic layer.

The present invention provides a porous structure enclosing an ordered alloy in the pores thereof produced at a heat-treatment temperature lower than in conventional processes.

### BRIEF DESCRIPTION OF THE DRAWINGS

FIGS. 1A and 1B are schematic sectional views for explaining the production process of the present invention.

FIG. 2 is a drawing for explaining the structure having fine pores useful in the present invention.

FIG. 3 is a drawing for explaining the structure of the present invention.

FIGS. 4A, 4B, 4C, 4D1, 4D2, 4E1, and 4E2 are drawings for explaining the process for the production of the present invention.

FIG. 5 is a drawing for explaining an example of a constitution of a magnetic recording medium employing the structure of the present invention.

FIGS. 6A, 6B, 6C, 6D1, 6D2, 6E1, and 6E2 are drawings for explaining the process for the production of the present invention.

FIGS. 7A, 7B, and 7C are schematic sectional views for explaining the production process of the present invention.

In the above drawings, the numerals denote the members as follows: 1000, a base member; 1011, a pore; 1012, a pore wall; 1050, a porous portion; 1055, a non-porous portion; 1122, a film formed on the pore; 1112, a film formed on the pore wall; 1022, a filled matter filled in the pores; and 1200, a second film.

### DETAILED DESCRIPTION OF THE INVENTION

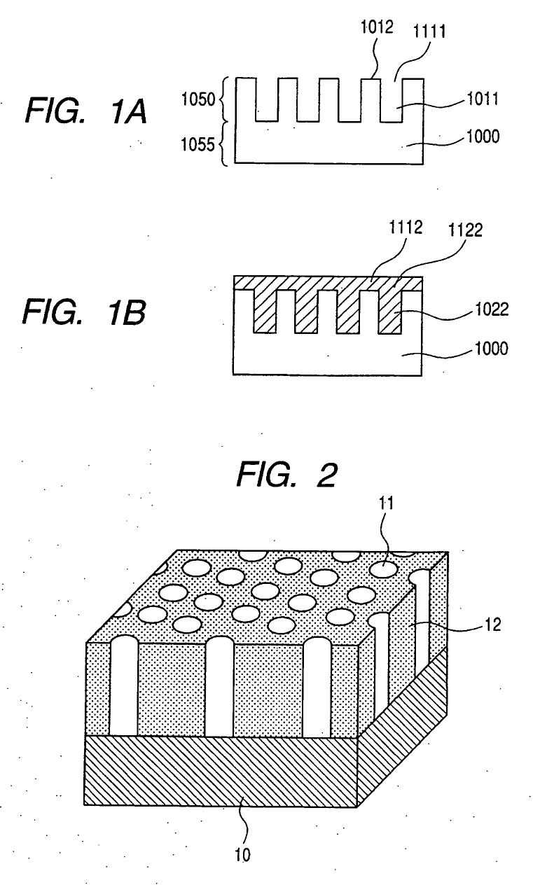

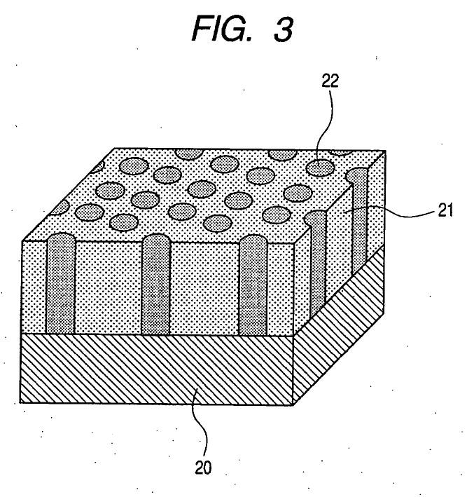

The process of the present invention for producing the structure enclosing an ordered alloy in the pores in the porous layer is explained below specifically by reference to FIGS. 1A and 1B.

Base member 1000 is prepared which has a porous layer on the surface as shown in FIG. 1A. The numeral 1011 denotes a pore, and the numeral 1012 denotes the other portions of the porous layer than the openings of the pores (hereinafter referred to as “pore wall”. FIGS. 1A and 1B are sectional views. Viewed from the top side of the pores of the base member illustrated in FIGS. 1A and 1B, the pores are dispersed as shown in FIG. 2. The numeral 1111 denotes a pore top in the present invention. In FIG. 2, the numeral 11 denotes a fine pore, and the numeral 12 denotes a pore wall interposed between the pores. This pore wall portion is occasionally called a matrix portion for distributing the pores. The pores are dispersed, or may be regularly distributed.

A first material constituting the alloy is filled into the pores 1022, and thereon a film of a second material constituting the alloy is formed on the pore tops and the pore wall as shown in FIG. 1B. In FIG. 1B, the numeral 1122 denotes a portion of the film formed on the pore tops, and the numeral 1112 denotes a portion of the film formed on the pore wall. The base member 1000 covered with the film on the pore top and the pore wall of the porous layer as shown in FIG. 1B is heat-treated. Thereby a structure containing an ordered alloy in the pores is produced.

(Base Member)

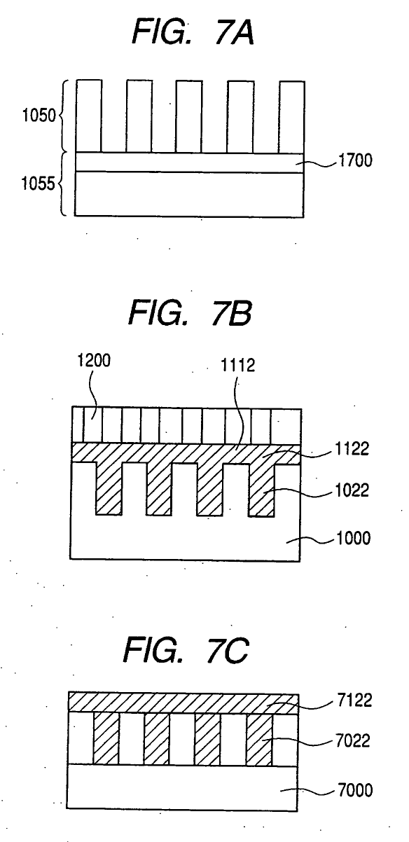

The base member 1000 may be formed on another substrate. A material may be provided which contributes to filling into the pore bottom portions of the pores. In FIG. 1A, the numeral 1050 denotes a porous portion of the base member, and the numeral 1055 denotes a non-porous portion. Between the porous portion and the non-porous portion, a second layer 1700 may be provided as shown in FIG. 7A.

The second layer has preferably a special function such as of controlling the orientation of the filling material.

The second layer may be formed from MgO (001), ZnO (001), or a like substance.

The symbol MgO (001) signifies a crystal of MgO in which the face (001) is parallel to the face of the non-porous portion 1055. Here the face of the non-porous portion 1055 is a face of the nonporous portion vertical to the pore depth direction.

This signifies that, in the MgO crystal, the normal line [001] of the face of the MgO crystal is vertical to the face of the non-porous portion (i.e., parallel to the pore depth direction).

The same is true regarding ZnO (001).

On the MgO (001) layer or the Zn (001) layer under the porous portion 1050, a still another layer may be provided which has an oriented face of (001) face or (111) face of an fcc structure.

The pores in the porous portion are columnar fine pores. The average pore diameter ranges, for example, from 1 nm to 100 nm, preferably from 1 nm to 40 nm. The depth of the pores (the length of the pores in the thickness direction) ranges from 5 nm to 500 nm, preferably not more than 100 nm, more preferably not more than 50 nm, still more preferably not more than 20 nm.

For filling the material into the pores in the porous portion by a dry process such as CVD, not by a wet process like plating, the aspect ratio of the fine pores is not more than 10, preferably not more than 5, still more preferably not more than 2. This is because, by a dry process, the filling of the material into the fine pores of small sectional diameters may be difficult or may take a long time.

The aspect ratio herein signifies the ratio of the length of the fine pore in the depth direction to the diameter in the section perpendicular to the pore depth direction.

The process of the present invention is effective for obtaining an ordered alloy in pores of the porous matter having an average pore diameter of not more than 15 nm and average pore interval between the pores of not more than 20 nm.

The base member is prepared by the method mentioned below.

For example, aluminum or an aluminum-containing alloy is anodized in a solution of oxalic acid, phosphoric acid, or the like to form fine pores, as described in Japanese Patent Application Laid-Open No. 2002-175621. This process gives a porous member having pores partitioned by alumina, an oxide.

In another example, as described in Japanese Patent Application Laid-Open No. 2004-237429, from a structure containing columnar members dispersed in a base member, the columnar members are removed to obtain a porous layer. This example is explained by reference to FIG. 2.

In FIG. 2, the numerals denote members as follows: 10, a substrate; 11, a fine pore; and 12, a base member having fine pores dispersed therein. Such a structure having fine pores can be obtained through the steps below.

Specifically, a structure is provided in which columns are surrounded by another material. The structure contains the material constituting the surrounding region at a content ranging from 20 atom % to 70 atom % based on the total of the columns and the surrounding region. Within the above range of the ratio, a structure can be obtained in which the columnar members are dispersed in the surrounding matrix region. The material constituting the columnar member includes Al, Au, Ag, and Mg. The material for constituting the column-surrounding region includes Si, Ge, mixtures of Si and Ge (hereinafter occasionally represented by “SiₓGe₁₋ₓ” (o<x<1)), and C. The structure having the columnar members dispersed in the surrounding region can be obtained by a non-equilibrium film formation such as sputtering with a target containing materials of both the columnar members and the surrounding region. This is explained later specifically in Examples.

(Filling)

The aforementioned first material filled into the pores and the material for constituting a film formed on the pore wall and pore top portions (the aforementioned second material) may be different from each other or may be the same. For example, in the case of an alloy composed of two metals M1 and M2, M1 is firstly filled into the pores, and thereon a film of M2 is formed, and the structure is heat-treated for alloy formation and ordering. Otherwise two metal materials for the alloy may be filled into the pores and the same materials are allowed to cover the pore wall and the pore top portions. In any method, the material filled into the fine pores and the material covering the pore wall and the pore top portions are preferably connected with each other.

Otherwise, all of the alloy-constituting metals are filled into the pores, and on the porous layer, a film is formed from a material other than the alloy-constituting materials (e.g., Cu, ZnO, or a Cu—Si lamination film), and then the ordering treatment is conducted. Specifically, as shown in FIG. 7C, a filling material 7022 is formed by filling all of the alloy-constituting material into the pores, and thereon a film 7122 is formed from a material which may be different from the alloy-constituting materials.

The filling operation can be conducted by plating, sputtering, or chemical vapor deposition.

When the first material and the second material are different from each other, one of the materials contains at least one of Fe, Co, and Ni, and the other material contains at least one of Pt and Pd. When the first material and the second material are the same, the material includes metal materials containing combination of Fe and Pd; Fe and Pt; Co and Pt; Fe and Pd; and Ni and Pt.

The film containing the alloy-constituting materials which is formed on the pore top portions and pore wall should be substantially continuous without interception, and has a thickness ranging from 1 nm to 1 μm, preferably from 3 nm to 100 nm, still more preferably from 5 nm to 30 nm.

When the alloy-constituting material is filled by plating into the fine pores, the filled material is allowed to overflow preferably from the pores of the porous layer and the material having overflowed from the pores becomes continuous on the pore wall.

The materials which can be filled by plating includes CuAu type or Cu₃Au type hard-magnetic ordered alloys such as FePt, FePd, CoPt, CoPd, FePd₃, Fe₃Pd, Fe₃Pt, FePt₃, CoPt₃, and Co₃Pt.

The alloys constituted of the same elements such as FePt, Fe₃Pt, and FePt₃ can be prepared selectively by controlling the ratio of Fe and Pt in the plating bath, and the plating conditions.

In the plating bath, the Fe source may be iron chloride or iron sulfate, and the Pt source may be a hexachloroplatinate (IV) salt.

In the plating bath, since Fe ions are relatively instable and liable to form a precipitate, a complexing agent may be added thereto for stabilization of the Fe ions. The complexing agent includes tartaric acid, citric acid, succinic acid, malonic acid, malic acid, and gluconic acid; and salts thereof. In particular, preferred are tartaric acid or its salts and/or citric acid or its salts; sodium tartarate and/or ammonium tartarate.

Deterioration of the hexachloroplatinate (IV) salt with time can be effectively prevented by addition of an excess of Cl⁻ ions of NaCl or the like into the plating solution. The hexachloroplatinate (IV) can further be stabilized in the solution by addition of ammonium ion to form a complex of ammonium hexachloroplatinate (IV) complex.

The intended composition of FeₓPt₁₋ₓ is obtained by controlling the ratio of the Fe source and the Pt source to be added to the plating solution and the plating potential. The change of the potential corresponds to the change of the electric current density per area of the working electrode. This current density affects the composition ratio of the plated product to be formed. Incidentally, an additive like a surfactant may be added to the plating solution.

With the aforementioned FePt plating solution, a structure can be obtained which contains a magnetic FePt of 20-80 atom % Fe filled into the fine pores. The constitution of FePt can be confirmed by fluorescent X-ray analysis (XRF), inductively coupled plasma analysis (ICP), or a like method.

For preparation of the CuAu type or Cu₃Au type of hard magnetic ordered alloy containing Co, Ni, Pd, and the like, a plating bath should be synthesized. The plating solution contains at least one of Fe, Co, and Ni. The plating bath containing Co ions or Ni ions is more stable and less liable to form a precipitate than the one containing Fe ions. A hexachloropalladate salt may be used as the Pd source.

The filling operation by a dry process, different from the wet process like plating, is explained below.

The dry process includes sputtering, CVD, and vapor deposition.

In particular, the arc plasma gun method is analogous to an ion-plating process for forming a film from an ionized particulate metal, and is proved to be a film-forming method especially suitable for embedding in wiring for damascene or the like. The arc plasma gun method utilizes arc plasma by a vacuum arc method which generates arcing for melting and ionizing vapor-deposited particles.

The filling density can be improved by applying a bias to the substrate. Another method, like ion-beam sputtering which projects the deposition particles straightly onto the substrate is suitable for filling into fine pores.

However, by the dry process, the film can be formed not only in the fine pores but also on inside walls of the fine pores and pore wall 1012, which can lower the filling density.

Therefore, in filling a material into fine pores of 50 nm diameter or finer by a dry process, the aspect ratio, (pore depth)/(pore diameter), is preferably not more than 5, more preferably not more than 2, still more preferably not more than 1.

The filling density can be improved, as necessary, by conducting alternately a step of removal of a deposit from the pore wall by etching and a step of filling. In filling into the pores by a dry process, some small voids may be formed without disadvantage. However, the aspect ratio, the filling method, and filling conditions are preferably selected not to cause void formation.

One of the above filling step and the film-forming step may be conducted by a dry process employing the alloy-constituting materials, or the both steps may be conducted by the same process.

After the film-forming step, namely after formation of the structure shown in FIG. 1B, on the film (1122, 1112), a second film 1200 constituted of a third material may be formed (FIG. 7B).

The second film serves to control orientation of alloy and/or to lower the ordering temperature for the ordered alloy formation.

An example of the second film is a lamination film of ZnO, Cu, or Cu and Si in which the face represented by (001) is oriented.

Another example of the second film is a film of a face-centered cubic structure (fcc) in which the face represented by (001) is oriented (the film having a (001) face on the surface when viewed in the direction perpendicular to the substrate). Other examples are (111) orientation films, MgO (001) orientation films and so forth.

(Heat Treatment)

The base member filled with an alloy-constituting material in the fine pores is heat-treated for ordering the filled alloy at a temperature ranging from 400° C. to 600° C., more preferably from 450° C. to 550° C. In a conventional technique, for ordering, the alloy filled in the fine pores should be treated at a temperature as high as 650° C. According to the present invention, the ordering temperature can be lowered. Naturally, the heat treatment temperature may be lower than 400° C., or the heat treatment may be omitted insofar as the alloy can be ordered.

The heat treatment is preferably conducted in a reductive atmosphere containing, for example, hydrogen. Thereby oxygen as an impurity contained in the filled material can be removed effectively to promote diffusion of the metal atoms.

The ordered alloy in the present invention includes CuAu type (L1₀ type) ferromagnetic ordered alloys and Cu₃Au type (L1₂ type) ferromagnetic ordered alloys.

The CuAu type alloys include FePd, FePt, and CoPt. The Cu₃Au type alloys include FePd₃, Fe₃Pd, Fe₃Pt, FePt₃, CoPt₃, Co₃Pt, Ni₃Pt, and NiPt₃. Further, an L1₁ type ordered alloy may also be used in the present invention. Such types of ordered structures are described, for example, Japanese Patent Application Laid-Open No. 2002-175621 (in FIG. 8 thereof).

A continuous film of several nanometers thick which is not interrupted by pore wall is known to be ordered at a lower heat treatment temperature. Specifically, an ordered alloy phase can be obtained at 350° C. as shown in the aforementioned known disclosure.

In the present invention, the heat treatment temperature for ordering the filled material is lowered by utilizing a continuous film which can be ordered at a relative low temperature.

In the continuous film, the ordered alloy phase is considered to be formed at a lower temperature owing to smooth diffusion of atoms, although the detailed mechanism is not known. This ordered alloy phase in the thin film induces the ordering of the alloy material in the fine pores. The contact of the material filled in the fine pores with the thin film on the porous layer promotes the diffusion for the ordering similarly as in the continuous film.

(Film Removal)

After the heat treatment, the film formed on the porous layer surface may be removed by polishing or grinding. In particular, for use of the structure of the present invention as the magnetic recording medium, the film is removed desirably.

(Structure)

The process for producing the structure of the present invention enables production of a structure in which the ordering degree varies in the depth direction of the fine pores.

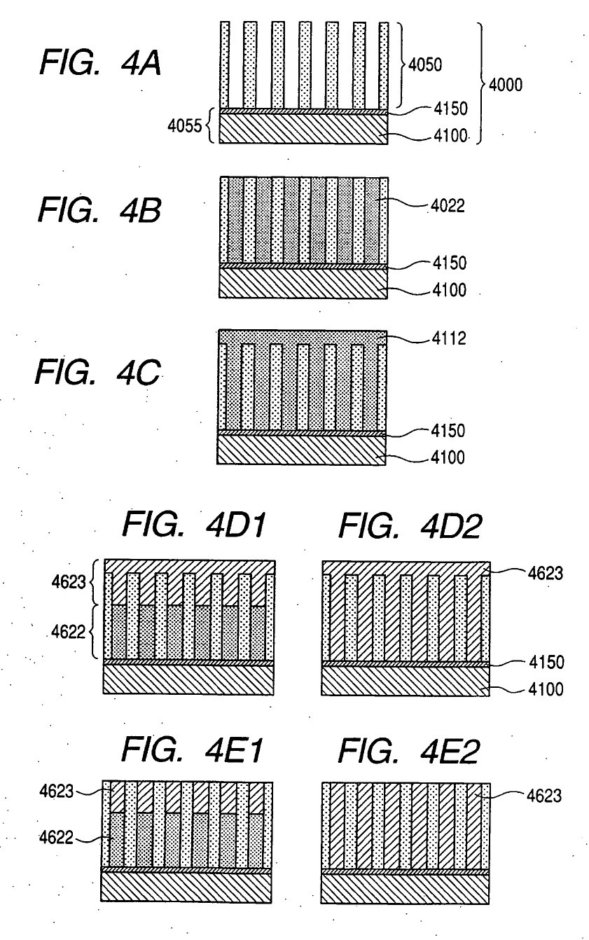

Specifically, as shown in FIG. 4E1, in the depth direction, a first region 4623 and a second region 4622 are provided in the depth direction in a columnar pore from the surface side (the side opposite to the substrate). In the first region, the alloy is ordered, whereas in the second region the alloy is ordered at an ordering degree lower than that of the first region, or the alloy is not ordered a non-alloyed region, or ordered structure is different from that of the first region.

The border between the first region and the second region need not be distinct. In a vertical magnetic recording medium employing a soft magnetic layer having a high magnetic permeability under a hard magnetic layer, the soft magnetic layer may be replaced by the second region.

Further, for adjusting a magnetic property (e.g., control of the upper limit of the coercive force), a second region may be utilized which is not ordered or is ordered at a lower ordering degree and has a lower coercive force.

Naturally, the second region may be a non-alloyed region.

The ordered structure of the second region may be different from that of the first region. For example, the first region has an L1₀ structure and the second region has an L1₁ or L1₂ structure.

The filler materials or constitution thereof may be changed within one and the same pore as below.

The second region is an ordered alloy region, and the first region is an alloy region having a lower ordering degree, a non-alloyed region, or a region having an ordered structure different from that of the second region.

In the present invention, the alloy constituting material in the fine pores is ordered starting from the continuous film formed on the porous layer. Therefore, by controlling the heat treatment time, the ordered alloy region (first region), and the alloy region having a less ordering degree or not ordered (second region) can be obtained in one fine pore.

By controlling the lengths of the first region and the second region, the magnetic properties of the structure, such as saturation magnetism and residual magnetization, can be changed without changing the thickness of the fine pores.

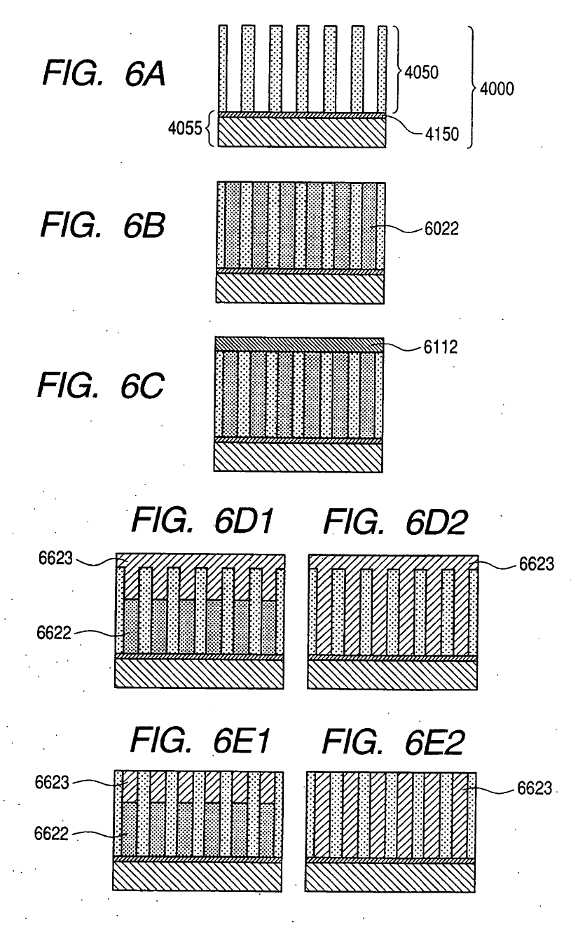

(Embodiment of the Present Invention Shown in FIGS. 4A-4E2 to FIGS. 6A-6E2)

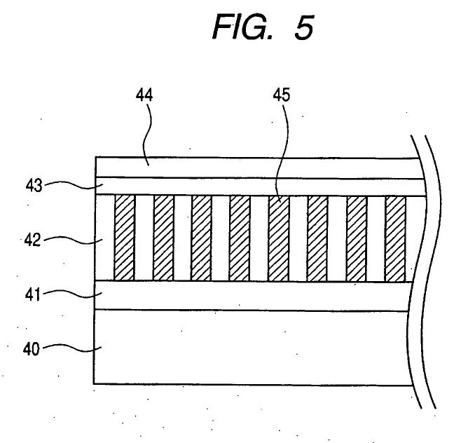

A structure of the present invention in which the alloy constituting material filled in the fine pores and the constituting material of the film formed on the porous layer having the fine pores are the same is explained by reference to FIGS. 4A-4E2 and FIG. 5.

FIGS. 4A-4E show the process flow.

Firstly, structure 4000 having fine pores is provided as shown in FIG. 4A. In the drawings, the numerals denote the members as follows: 4050, a porous layer portion; 4055, a non-porous layer portion; 4100, a substrate; and 4150, a layer interposed between the substrate and the porous layer portion. Then a filling material 4022 containing Fe and Pt for formation of the FePt alloy is filled into the pores as shown in FIG. 4B. The plating is continued to form a thin film (continuous film), in a thickness for example about 10 nm, outside on porous layer portion 4050 as shown in FIG. 4C.

Thereafter, heat treatment is conducted to form an ordered alloy phase (FIG. 4D1). The prepared FePt magnetic material immediately after the plating before the heat treatment is an alloy having an fcc phase (the alloy phase being amorphous in some cases), but does not have the order represented by L1₀.

In FIG. 4D1, the filled material in the pores of the porous layer has an ordered alloy structure in first region 4623 apart from the substrate. In second layer 4622 near to the substrate side, the ordered alloy structure is not formed or the ordering degree is lower than the first region. In FIG. 4D2, on the other hand, the ordered alloy phase is formed in both of the first region and the second region.

The Cu₃Au type ordered alloy phase (L1₂) of Fe₃Pt or FePt₃ is formed at a temperature lower than that of the CuAu type ordered alloy (L1₀). For formation of an L1₀ type ordered alloy of larger anisotropic magnetism, a higher temperature is necessary than for formation of the L1₂ type alloy. A higher coercive force (Hc) suitable for a magnetic recording medium can be obtained by such ordering.

As shown in FIGS. 4D1 and 4D2, an ordered alloy phase can be prepared in upper portions or the entire portions of the columnar structure depending on the film thickness of the porous structure and the heat treatment conditions (temperature and time).

Next, thin film 4112 is selectively removed to obtain a structure in which columns of a CuAu type or Cu₃Au type hard-magnetic ordered alloy are isolated in a matrix of silicon oxide or the like as shown in FIG. 4E1 or 4E2. By precision polishing with a diamond slurry, colloidal silica, or the like, flatness can be achieved with nms (mean square) of roughness of 1 nm or smaller.

The aforementioned structure is useful as a magnetic layer of a magnetic recording medium. FIG. 5 shows an example of the magnetic recording medium. The numerals denote the members as follows: 40, a substrate; 41, an underlying electrode layer; 42 a recording layer; 43, a protection layer; and 44, a lubrication layer. Substrate 40 may be a glass plate, an Al plate, or a Si plate. For securing hardness, a NiP film is preferably formed by plating or a like method as an underlayer. Between substrate 40 and recording layer 42, a soft-magnetic layer is effectively formed as a backing layer. As the backing layer, useful is a film constituted mainly of NiₜFe₁₋ₜ (t ranging preferably from 0.65 to 0.91) and the film may contain further Ag, Pd, Ir, Rh, Cu, Cr, P, or B. An amorphous soft magnetic material such as FeTaC and CoZrNb is useful therefor.

On the backing soft-magnetic layer, an orientation-controlling layer like (001)-oriented MgO is preferably inserted for controlling the orientation of the magnetic material filled in the recording layer. Further on the orientation-controlling layer, an electrode layer for plating is preferably provided. The electrode layer is preferably oriented by utilizing the orientation-controlling layer. ZnO or the like may be used for serving as the orientation-controlling layer and electrode. For controlling the orientation of the magnetic material filled in the pores, the orientation of the underlying electrode layer is selected preferably from (111) and (001). In the magnetic material of the present invention, for orienting the c-axis of the ordered alloy layer in the direction vertical to the substrate board, the underlying electrode layer has preferably a tetragonal crystal orientation parallel to the substrate face. In particular, (001) orientation of an fcc structure is preferably utilized. The recording layer is preferably protected by a surface-protection layer. The surface protection layer is effectively formed from carbon, or a high-hardness non-magnetic material such as carbides and nitrides for abrasion resistance against friction with a head. Additionally, PFPE (perfluoropolyether) is preferably applied thereon as a lubrication layer. The magnetic recording medium of the present invention is useful as a vertical magnetic recording medium.

Next, the structure of the present invention in which the material for the film formed on the porous layer having the fine pores is different from the material for the alloy filled in the fine pores is explained by reference to FIGS. 6A-6E2.

FIGS. 6A-6E2 show a flow of a process of an embodiment of the present invention.

As an example, a FePt magnetic material is prepared. Structure 4000 as mentioned above having the fine pores is prepared (FIG. 6A). In FIGS. 6A-6E2, the same reference numerals as in FIGS. 4A-4E2 are used for denoting the corresponding members. By a first plating operation, Fe or Pt is filled in the pores of the structure to form filling 6022 in the pores (FIG. 6B). An intermediate layer 4150 may be formed as necessary between the porous layer and the substrate. In particular, when Pt is filled, the filling operation can be conducted not only by electroplating but also by electroless plating. The electroless plating is efficient since hydrogen evolution is not caused in the filling process. After the plating, the top end faces of the fine pores may be uncovered at the surface as necessary. Otherwise, on the structure, thin film 6112 is formed as shown in FIG. 6C from a material different from that of the first plating material: Pt onto Fe, or Fe onto Pt. This thin film may be formed by any method including gas-phase methods such as sputtering and vapor deposition, and liquid phase methods such as plating.

Thereafter, the structure is heat-treated to cause counter diffusion at the interface between thin film 6112 and the filling in the fine pores to form a FePt ordered alloy.

In FIG. 6D1, the alloy phase is ordered in first region 6623 of the filling in the fine pores apart from the substrate side in the porous layer. In second region 6622 near to the substrate side, the ordered alloy phase is not formed, or the ordering degree is lower than in the first region. On the other hand, in FIG. 6D2, the ordered alloy phase is formed entirely including the second region.

In the next step, as shown in FIGS. 6E1 and 6E2, the thin film portion is removed by polishing or grinding to prepare a structure useful as a magnetic recording medium layer.

Not only the CuAu type of FePt ordered alloy but also the Cu₃Au type ordered alloy such as Fe₃Pt and FePt₃ can be formed by controlling the film thickness of the porous nano-structure, the thickness of the thin film, and the heat-treatment conditions. Further, the CuAu type and the Cu₃Au type of ordered alloy can be allowed to coexist separately at the upper portion and lower portion of the pores.

The FePt magnetic material is explained above. However, the material is not limited thereto. Other CuAu type or Cu₃Au type of ordered alloy phases can be formed from other materials.

Further improvement of the properties of the magnetic recording medium is explained below.

For use as the recording layer of the magnetic recording medium, the alloy phase of the present invention is desirably ordered at a lower temperature.

In the order-disorder transformation of the alloy, the diffusion energy of counter diffusion of the constituting atoms and an elastic energy caused by lattice deformation can affect the activation energy of the ordering.

Addition of a third element like Cu is known to promote crystallization of the ordered alloy to lower the ordering temperature (Japanese Patent Application Laid-Open No. 2002-216330).

Therefore, in the present invention also, addition of Cu or the like to the ordered alloy filled into the fine pores and to the continuous film of the ordered alloy formed on the pore wall can lower the ordering temperature.

Further, the ordering temperature can be lowered by utilizing the deformation energy caused by the lattice deformation of the underlying layer (the layer under the porous layer in the present invention) and difference of the film stress.

In the above techniques, a layer is provided which induces deformation energy (the layer being referred to as a deformation-inducing layer) under the ordered alloy layer.

When a Cu layer is formed as an underlying layer in a thickness of about 100 nm on the Si substrate, a silicide is formed by the heat-treatment. The deformation energy caused in the silicide formation is effective in lowering the ordering temperature (Applied Physics Letters, Vol. 85, 4430-4432 (2004).

The formation of the deformation-inducing layer on the structure of the present invention, namely the structure containing an ordered alloy in the fine pores and covered with a continuous film on the pore wall, is effective in lowering the ordering temperature of the continuous film and promoting the ordering in the fine pores.

In consideration of the promising vertical magnetic recording mediums having a backing soft magnetic layer, aforementioned Si and Cu layer are necessary to be formed between the soft magnetic layer and the recording layer. However, this layer can enlarge the distance between the recording layer and the backing soft magnetic layer to lower the recording properties.

In the structure of the present invention, the continuous layer on the pore wall and the deformation-inducing layer can be removed by polishing or an etching process. Therefore the distance between the recording layer containing the ordered alloy in the fine pores and the soft-magnetic layer is not increased, and a satisfactory magnetic recording medium can be provided.

For use as the recording film, the crystal orientation of the recording medium should be controlled. Therefore, in the above explanation, the orientation is controlled by insertion of an orientation-controlling layer such as MgO between the soft-magnetic layer and the recording layer.

The crystal orientation of the continuous film, which can readily become ordered, can be controlled by formation of an orientation-controlling layer on the continuous film on the pore wall.

The filled material such as FePt in the fine pores not only becomes ordered but also crystal growth is promoted by the orientation of the above-placed continuous film. Thereby, the ordered alloy phase can be obtained with orientation control in the fine pores.

The orientation-controlling layer can be formed from ZnO.

The ZnO film is formed by sputtering with c-axis orientation exhibiting a strong diffraction lines of (002) of XDR by selecting the film formation conditions.

Conventionally, in use of ZnO as the orientation-controlling layer, the oxidation reaction at the interface of the ZnO in the heat treatment causes a problem.

However, in the recording medium from which the upper continuous layer and the orientation-controlling layer are removed, the ordered alloy in the fine pore for the recording layer is not brought into direct contact with the ZnO. Therefore, excellent recording medium can be provided irrespectively of the oxidation reaction at the interface.

Although only some exemplary embodiments of the invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### EXAMPLES

The present invention is described more specifically by reference to Examples.

### Example 1

An example is shown of the process for production of a nano-structure of the present invention (FIGS. 4A-4E2).

A Si substrate is used as substrate 4100. On the Si substrate, a Pt film of 20 nm is formed as underlayer 4150. On this underlayer, a thin film of an AlSi structure composed of AlSi is formed in a thickness of 25 nm. (The AlSi in this Example may be replaced by AlGe, or AlSiGe.) According to observation of the thin film of the AlSi structure thin film by FE-SEM (field emission scanning electron microscopy), Al-containing round columns are arranged two-dimensionally in a Si region. The fine pores for formation of the Al-containing columnar member have a diameter of 8 nm, and the average center-to-center interval is 10 nm. This AlSi structure thin film contains Si at a content of 40 atom % based on the total AlSi by inductively coupled plasma spectroscopy.

The above AlSi structure thin film is formed by magnetron sputtering by placing eight Si chips of 15 mm square on a circular Al target of 4-inch diameter (101.6 mm) under the sputtering conditions: RF power source, Ar flow rate of 50 sccm, discharge pressure of 0.7 Pa, input power of 1 kW, and substrate temperature of room temperature (25° C.).

Other AlSi structures of the Si content of 20-70 atom % based on total AlSi can be formed by adjusting the Al/Si ratio. Processes for producing such structures are disclosed in International Patent Application Laid-Open Nos. WO03/069677, WO03/078687, WO03/078688, WO03/078685, and so forth.

The formed thin film is immersed in an aqueous 2.8% ammonia solution (pH: 10.8) at a room temperature for about 10 minutes to etch selectively the Al-columnar structure portion to form fine porous member (FIG. 2). The surface of the porous member is observed by FE-SEM. Thereby the structure is confirmed to have pores of 8 nm diameter at intervals of 10 nm. According to further observation of the cross-section of the structure by FE-SEM, the Al-containing column portion is found to have been completely dissolved and the formed nano-holes are partitioned by Si to be independent from each other. No film is observed at the bottoms of the fine pores, suggesting that the underlayer surface is bared. The nano-porous structure produced by this process is partially oxidized to form an oxide SiOₓ.

Into the pores of the nano-porous structure with the Pt surface of the underlayer bared at the bottoms of the fine pores, an FePt alloy is filled by plating. The plating solution contains 0.011 mol/L hexachloroplatinate (IV) salt, 0.022 mol/L ammonium chloride, 0.02 mol/L iron sulfate, 0.02 mol/L ammonium tartrate, and 0.1 mol/L sodium chloride.

The bath temperature is controlled at 50° C., and the pH is adjusted to 8.

Sodium dodecylsulfate may be added at a concentration of 0.0001 mol/L as a surfactant to the bath. The FePt alloy is filled into the fine pores by plating in the above plating bath.

The constitution of the plated FePt alloy can be controlled by plating conditions. Here, 50 atom % Fe—Pt is formed. By continuing the above plating, an FePt thin film can be formed continuously on the top portions of the FePt columnar structure filled in the fine pores.

In other words, the material deposited and filled in the fine pores comes to overflow out of the pores, and portions of the filling material having overflowed from the fine pores join together on the fine pore tops and the pore walls to form a continuous thin film. In this state, the structure is heat-treated for the ordering.

The thin film should be a continuous film, having a thickness preferably of about 10 nm. Since this thin film is removed after the heat treatment as mentioned below, the thickness is preferably about 10 nm in consideration of the grinding work for the removal and saving of the removed material.

The structure prepared by the above process is heat-treated at 500° C. during 30 minutes. After the heat treatment, the FePt thin film portion is removed by grinding to bare the top portions of the columnar structure. The formation of the L1₀ structure of the alloy material filled in the fine pores is confirmed by X-ray diffraction peaks of the L1₀ structure. Otherwise the formation of the ordered structure can be estimated from the difference in the coercive force from that of the same amount of the magnetic material as mentioned later.

As a comparative example, a columnar structure FePt filled in the fine pores is prepared. The structure of this Comparative Example 1 does not have an FePt alloy thin film on top of the FePt alloy column structure. (That is, the depth of the fine pores is equal to the thickness of the filled material). This prepared structure is heat-treated at 500° C. during 30 minutes. The structure of Example 1 and the structure of Comparative Example 1 are respectively subjected to hysteresis loop measurement by AGM (alternating gradient magnetometer) to measure the difference of the coercive force. The structure of Comparative Example 1 has a coercive force as low as about several hundred Oe, while the structure prepared by the process of Example 1 has a coercive force of not lower than 3000 Oe. Presumably, in the structure of Example 1, an L1₀ ordered alloy phase is formed in the thin film portion of the structure, and this ordered alloy phase induces formation of an L1₀ ordered alloy phase in the upper portion of the columnar structure. On the contrary, the structure of Comparative Example 1 which does not have the thin film portion as the ordering-promoting portion is presumed to be slow in formation of the L1₀ ordered alloy phase.

Thus the structure of Example 1 is useful in production of the magnetic recording medium.

In the above description, an L1₀-FePt is prepared from an FePt alloy of a 50 atom %-FePt.

A Cu₃Au type alloy such as Fe₃Pt and FePt₃ having an L1₂ structure can be formed in the fine pores by use of a plating bath of a different ratio of Fe and Pt as the plating source and by controlling the plating conditions.

After formation of the columnar structure by filling an FePt alloy of 50 atom % Fe—Pt in the fine pores as above, the step below can be conducted. That is, after filling into the fine pores, an FePt alloy of 75 atom % Fe—Pt and 25 atom % Fe—Pt different in composition from the above FePt is formed as the thin film to be connected with the columnar structure.

Incidentally, 75 atom % Fe—Pt represents an alloy of the composition of Fe_{0.75}Pt_{0.25}.

After heat-treatment of such a composite structure of this constitution, the columnar structure portion has an L1₀ structure and the top thin film portion has an L1₂ structure. This structure may be polished to make the surface flat with the top thin film portion not completely removed for use as a recording layer of a magnetic recording medium.

An example is the structure shown in FIG. 7C which has a first magnetic layer 7022 having pores filled with a magnetic material on substrate 7000 and a second magnetic layer 7122 formed further thereon. More specifically, the first magnetic layer is provided on substrate 7000, and the second magnetic layer is provided on the first magnetic layer. In the first magnetic layer, a first magnetic material is distributed in a nonmagnetic material, and in the second magnetic layer, the second magnetic material is continuous. The first magnetic material and the second magnetic material are preferably different from each other in a magnetic property, even when the two magnetic materials are constituted of the same elements. Naturally, the two magnetic materials may be different in the constituting elements. Preferably the coercive force of the first magnetic layer is stronger than that of the second magnetic layer by a factor of not less than 5, more preferably not less than 10, still more preferably not less than 50. The structure in which the second magnetic layer is soft-magnetic and the first magnetic layer is hard-magnetic is useful for a vertical recording medium.

The present invention includes such a constitution of the magnetic recording medium.

In the above description, the porous layer-containing member having the porous layer portion is formed from Al and Si as the starting member. However, the material is not limited thereto.

For example, the porous layer-containing member may be constituted of columnar aluminum portions composed of aluminum and a partitioning portion constituted of Si, Ge, or SiGe for surrounding the side faces of the columnar aluminum portions.

In the structure, columnar Al portions stand straight in the direction vertical to the substrate, and a Si portion surrounds the side faces of the columns as the matrix. In some cases, a slight amount of Si intermingles with the Al portion, and a slight amount of Al intermingles with the Si portion. This structure is preferably prepared by simultaneous film formation in a non-equilibrium state of Al and Si. The columnar Al portions standing straightly perpendicular to the substrate are selectively dissolved and removed by immersion into an acid or alkali capable of dissolving the Al portions. Acids and alkalis such as phosphoric acid, sulfuric acid, and aqueous ammonia are useful for the dissolution.

The columnar Al portions can also be removed by anodization of the AlSi structure in an aqueous solution like sulfuric acid. During the anodization, the Si portion is oxidized to (AlₓSi₁₋ₓ)_{z}O_{1-z}, where x is in the range of 0<x<0.2, preferably 0<x<0.1, and the oxidation state is in the range of 0.334<z<1, including a non-oxidized state. The anodization is stopped preferably at the time of 30-60 seconds after growth of the pores to reach the underlayer. Otherwise, the anodization may be continued until the electric current of the anodization reaches the minimum. Otherwise, the oxidation may be conducted by annealing in an oxygen atmosphere.

The AlSi structure after removal of Al contains pores of the diameters ranging from 1 nm to 15 nm at pore intervals ranging from 3 nm to 20 nm depending on the composition. As described above, the partition for surrounding the fine pores 11 is constituted of Si or an oxide thereof depending on the means for removal of Al.

Specific examples of the aforementioned structure composed of Si, Ge, or SiGe are disclosed in Japanese Patent Application Laid-Open Nos. 2003-266400, and 2004-179229.

In the above Example 1, FePt alloys are used as the recording medium. However, ordered alloys having high magnetic anisotropy other than FePt, and FePtCu containing an additive like Cu and the like are also useful.

### Example 2

An example of the process for producing the nano-structure of the present invention is described (FIGS. 6A-6E2).

A porous member is prepared, in the same manner as in Example 1, through steps of forming a thin film of an AlSi structure on an underlayer, and etching selectively the Al columnar structure portion.

Into the pores of the above-obtained nano-porous structure with the surface of the underlying electrode bared at the bottoms of the pores, a plating material containing at least one of Fe, Co, and Ni is filled by plating. In this Example, Fe is filled. However, other elements can be filled by plating. Fe can be plated in various plating baths. Usually, Fe is plated in a plating bath containing iron chloride, iron sulfate, or a mixture thereof. However, a stable Fe plating bath can be prepared by use of iron sulfamate, iron tartrate, iron citrate, or the like forming a complexes in the solution. Excessive plating outside the pores should be avoided. The excess plated portion having overflowed should be removed by grinding or a like method to bare the top faces of the columnar structure filled in the pores.

Thereon, a film of a metal like Pt or Pd is formed which is capable of forming a CuAu type or Cu₃Au type ordered alloy with the above employed Fe, Co, or Ni. The film may be formed by plating, sputtering, or vapor deposition. In this Example, the film is formed by plating. Pt can be plated in various plating baths similarly as the Fe plating. The plating bath is selected which does not dissolve the Fe on the underlying surface. Here a solution of cyclohexachloroplatinic acid having pH adjusted to 7 by sodium hydroxide is employed. The plating thickness ranges preferably from about 10 nm to about 20 nm.

After the plating, the structure is heat-treated at 550° C. during 30 minutes to form a CuAu type or Cu₃Au type ordered alloy phase by counter diffusion at the Pt/Fe interface. Thereafter the surface is polished to remove the surface thin film to bare the top face of the columnar structure. The coercive force Hc of the structure is about 3000 Oe by AGM measurement.

In this Example 2, since a large volume of the Pt thin film is formed on the top of the columnar structure, the counter diffusion occurs to cause readily the ordering in comparison with Comparison Example 1 in which the ordering is caused by diffusion of Fe and Pt within the limited columnar structure. In this Example, the ordered alloy phase can be formed in limited upper portions of the columnar structure or in the entire of the columnar structure by controlling the film thickness of the firstly prepared AlSi structure, heat treatment temperature, and other conditions.

A magnetic recording medium can be prepared by using the structure of this Example 2 as the recording medium.

### Example 3

An example of the process for producing the nano-structure of the present invention is described (FIGS. 6A-6E2).

A porous member is prepared through steps of forming a thin film of an AlSi structure on an underlayer, and etching selectively the Al columnar structure portion. The underlayer herein serves as an electrode layer in electroplating or a catalytic layer in electroless plating depending on the process.

Into the pores of the above-obtained nano-porous structure with the surface of the underlying electrode bared at the bottoms of the pores, a plating material containing at least one of Pt and Pd is filled by plating. Pt and Pd can be deposited either by electroplating or electroless plating. In the electroless plating, since the electric conductivity in not necessary, the thickness of the underlayer may be several nanometers. The underlayer is Pd of 5 nm thick. In this Example, a commercial electroless Pt-plating bath is employed. This electroless Pt-plating solution is prepared by mixing (1) Electroless Pt 100 Basic Solution: 100 mL, (2) aqueous 2.8% ammonia solution: 10 mL, (3) Lectroless Pt 100 Reducing Solution: 2 mL, and (4) pure water: 88 mL. The pH of the plating solution is 11. Pt is filled into the pores with this plating solution kept at 60° C. The excess of Pt is removed by polishing or a like operation to bare the top face of the columnar structure in the same manner as in Example 2.

Then, a film of a metal like Fe, Co, or Ni is formed which is capable of forming a CuAu type or Cu₃Au type ordered alloy with Pt on the face of the above structure. The film may be formed by plating, sputtering, or vapor deposition. In this Example, FePt plating is conducted. Fe plating is conducted in the same manner as in Example 1. The film thickness is about 10 nm.

After the plating, the structure is heat-treated at 550° C. during 30 minutes to form a CuAu type or Cu₃Au type ordered alloy phase by counter diffusion at the Pt/Fe interface. Thereafter the surface is polished to remove the surface thin film to bare the top faces of the columnar structure. The coersive force Hc of the structure is about 3000 Oe or more by AGM measurement.

In this Example 3, since a large volume of the Fe thin film is formed on the top of the columnar structure, the counter diffusion readily occurs to cause readily the ordering in comparison with Comparison Example 1 in which the ordering is caused by diffusion of Fe and Pt within the limited columnar structure. In this Example, the ordered alloy phase can be formed either in limited upper portions of the columnar structure or in the entire of the columnar structure by controlling the film thickness of the firstly prepared AlSi structure, heat treatment temperature, and other conditions.

A magnetic recording medium can be prepared by using the structure of this Example 3 as the recording medium.

### Example 4

### Filling by Dry Process

An example of the process for producing the nano-structure of the present invention is described.

A porous member is formed in the same manner as in Example 1.

A Si substrate is used as substrate 4100 shown in FIGS. 4A-4E2. On the Si substrate, a MgO film of 10 nm thick is formed as underlayer 4150. On the underlayer, an AlSi structure thin film of 15 nm thick is formed. (The AlSi portion of this Example may be replaced by AlGe or AlSiGe.) In this AlSi structure film, plural Al columns are surrounded by a Si matrix.

According to observation by FE-SEM (field emission scanning electron microscopy) of this AlSi structure thin film, Al-containing round columnar members are arranged two-dimensionally in the Si matrix. The fine pores for formation of the Al-containing columns has pore diameters of 8 nm. The average interval between the pore centers is 10 nm.

The formed thin film is immersed in an aqueous 2.8% ammonia solution (pH: 10.8) for 10 minutes to etch selectively the Al column structure portions to form a porous member (FIG. 2). According to observation of the surface of the porous member by FE-SEM, the pores have a diameter of 8 nm, and are distributed at intervals of 10 nm. Further, according to FE-SEM observation of the sectional structure, Al-containing column portions have completely been dissolved, and the nano-holes are independently separated by Si. No residual film is observed on the pore bottoms, this suggesting that the underlayer surface is bared. The nano-porous member prepared by this procedure is an oxide SiOₓ owing to partial oxidation in the etching step.

The pores of this porous member are filled completely with an FePt alloy by an arc plasma gun method and further thereon a continuous film of FePt is formed in a thickness of 5 nm. The formed continuous film has a rough surface with the thickness of the continuous film larger on the pore wall portion.

The structure prepared as above is heat-treated at 500 during 30 minutes, and thereafter the FePt continuous film portion is polished away to bare the top portion of the columnar structure. The coercive force Hc of the structure is not less than 3000 Oe by AGM measurement.

### Example 5

### Formation of Orientation-Controlling Layer on Porous Layer

An example of the process for producing the nano-structure of the present invention is described.

In the same manner as in Example 1, a porous member is formed, a material for formation of an ordered alloy is filled in the fine pores, and a continuous film is formed on the pore wall.

An example of an FePt alloy is described here. However, an ordered alloy having a high magnetic anisotropy other than the FePt, or FePtCu or the like containing a third additive like Cu may be used in place of the FePt alloy.

The structure shown in FIG. 1B is formed. On this structure, as shown in FIG. 7B, a ZnO layer (1200 in FIG. 7B) is formed as an orientation-controlling layer by sputtering.

The ZnO is formed in a film thickness of 40 nm by magnetron sputtering in an argon atmosphere of 15 mTorr at a substrate temperature of 300° C. The XRD diffraction pattern shows a large peak of (002) of ZnO and growth of ZnO oriented in the c-axis on the disordered FePt layer.

Then the structure is heat-treated at 500° C. during 30 minutes. Thereby, the continuous film and the filled FePt come to be ordered. The XRD diffraction pattern shows large peaks of (001) and (002) showing c-axis orientation of FePt. Thus it is confirmed that the orientation of FePt can be controlled by ZnO formed on the top. After removal of the laminated matter containing ZnO on the pore wall by polishing also, the XRD diffraction pattern shows c-axis orientation of FePt similarly as above. This shows that the filled FePt is also orientation-controlled.

### Example 6

### Formation of Ordering Temperature-Lowering Layer on Porous Layer

An example of the process for producing the nano-structure of the present invention is described.

In the same manner as in Example 1, a porous member is formed, a material for formation of an ordered alloy is filled into the fine pores, and a continuous film is formed on the pore wall with an FePt alloy. The structure shown in FIG. 1B is formed. In formation of the FePt alloy by plating, the structure is heat-treated in a hydrogen-reducing atmosphere at 300° C. to remove impurity, especially a hydroxide. When the FePt is formed by a dry process, this heat treatment is not necessary. On this structure, continuous film 1200 is formed as a buffer layer constituted of 20-nm Pt, 30-nm Cu, and 10-nm Si formed in this order. After the film formation, the structure is heat treated at 400° C. during 30 minutes, and then the continuous FePt thin film portion is removed by grinding to bare the top portion of the columnar structure. A strain energy of Cu silicide formed at about 300° C. promotes the ordering of FePt. The coersive force Hc is not less than 3000 Oe by AGM measurement. The upper strain-inducing layer formed from the Cu and Si layers can lower the ordering temperature for the FePt ordered alloy phase formation in the pores.

### INDUSTRIAL APPLICABILITY

The process of the present invention for producing the structure is useful as a constitution material of a recording medium such as a hard disk and a memory.

This application claims priority from Japanese Patent Application No. 2005-102597 filed Mar. 31, 2005 and Japanese Patent Application No. 2005-270286 filed Sep. 16, 2005 which are hereby incorporated by reference herein.

What is claimed is:

1. A process for producing a structure containing an ordered alloy in pores in a porous layer comprising the steps of:
providing a porous layer-containing member having a porous layer on the surface thereof,
filling a first material for being comprised in the alloy into pores of the porous layer,
forming a film containing a second material on the porous layer, and
heat-treating the member having the film.

2. A process for producing a structure containing an ordered alloy in pores in a porous layer comprising the steps of:
providing a porous layer-containing member having a porous layer on the surface thereof,
filling a first material for being comprised in the alloy into pores of the porous layer,
forming on the porous layer-containing member a film from a second material for being comprised in the alloy to be connected with the filled first material and to cover the openings of the pores and the other portions of the porous layer than the openings, and heat-treating the porous layer-containing member with the film covering the openings and the other portions than the openings.

3. The process for producing a structure according to claim 1, wherein the first material and the second material are different from each other.

4. The process for producing a structure according to claim 1, wherein one of the first material and the second material contains at least one element selected from the group consisting of Fe, Co and Ni, and the other one of the first material and the second material contains at least one of the elements of Pt and Pd.

5. The process for producing a structure according to claim 1, wherein the first material and the second material are the same.

6. The process for producing a structure according to claim 1, wherein the ordered structure of the ordered alloy is an L1₀ type structure or an L1₂ type structure.

7. The process for producing a structure according to claim 1, wherein the pores of the porous layer are columnar, having an average diameter ranging from 1 nm to 40 nm.

8. The process for producing a structure according to claim 1, wherein the pore-filling step and the film-forming step are conducted by plating the material constituting the alloy.

9. The process for producing a structure according to claim 8, wherein the plating treatment is conducted to allow the material to overflow from the pores of the porous layer and to allow the material having overflowed to join together to be continuous on the other portions than the openings of the pores.

10. The process for producing a structure according to claim 1, wherein at least one of the pore-filling step and the film-forming step is conducted by a dry process by use of the material constituting the alloy.

11. The process for producing a structure according to claim 1, wherein the film formed in the film-forming step on the porous layer-containing member is a continuous film having a thickness of not less than 1 nm.

12. The process for producing a structure according to claim 1, wherein the process further comprises, after the film-forming step, a step for forming a second film containing a third material on the film.

13. The process for producing a structure according to claim 12, wherein the second film serves to lower the temperature for orientation control and/or ordering of the alloy.

14. The process for producing a structure according to claim 12, wherein the second film is selected from films of ZnO, MgO, and Cu, and lamination films of Cu and Si.

15. The process for producing a structure according to claim 1, wherein the heat-treating step is conducted in a reductive atmosphere.

16. The process for producing a structure according to claim 1, wherein the process comprises a step of removing the film from the member.

17. A process for producing a structure containing an ordered alloy in pores in a porous layer comprising the steps of:
providing a porous layer-containing member having a porous layer on a surface,
filling a first material for being comprised of the alloy in the pores of the porous layer,
forming a film containing a second material on the porous layer to be in contact with the filled first material, and
treating the filled first material for formation of an ordered alloy.

18. A structure having a member having a columnar pores on a substrate and containing a filling in the pores, wherein the filling has a first region and a second region in the depth direction of the columnar pore,
the first region is an ordered alloy region, and the second region is an ordered alloy region of a lower ordering degree than the first region, non-alloyed region, or a region having an ordered structure different from the first region.

19. A recording medium having a magnetic layer on a substrate, wherein the magnetic layer is constituted of a first magnetic layer and a second magnetic layer; in the first magnetic layer, a first magnetic material is distributed in a non-magnetic material, and in the second magnetic layer, a second magnetic material is continuous.

20. The magnetic recording medium according to claim 19, wherein the first magnetic material and the second magnetic material are different in a magnetic property.

21. The magnetic recording medium according to claim 19, wherein the first magnetic layer has a larger coercive force than the second magnetic layer.
